(19) United States
(12) Patent Application Publication
(10) Pub. No.: US 2004/0255689 A1
(43) Pub. Date: Dec. 23, 2004

(54) Flow rate test apparatus and method

(76) Inventors: Sabrina L. Murray, Longmont, CO (US); Michael Murray, Longmont, CO (US); Roger A. Jessen, Longmont, CO (US)

Correspondence Address: Seagate Technology LLC, 1280 Disc Drive, Shakopee, MN, 55379, US

(21) Appl. No.: 10/817,610

(22) Filed: Apr. 2, 2004

Related U.S. Application Data
(60) Provisional application No. 60/460,077, filed on Apr. 3, 2003.

(51) Int. Cl. G01F 1/00

(52) U.S. Cl. 73/861

(57) ABSTRACT

Method and apparatus for performing a leak rate test on a device under test (DUT), such as a data storage device housing. A flow meter determines a flow rate for a flow of pressurized fluid. A conduit provides a first portion of the fluid from the flow meter to the DUT, and a bleed orifice removes a second portion of the fluid from the conduit at a selected removal rate. A leak rate for the DUT is obtained in relation to the determined flow rate and the selected removal rate. The bleed orifice raises the determined flow rate through the flow meter to a mid-range value, allowing quick and efficient flow rate testing including for relatively low specified leak rates. A regulator establishes the flow of pressurized fluid and preferably utilizes a variable orifice size to reduce flow oscillations in the pressurized fluid.

### RELATED APPLICATIONS

The present application makes a claim of domestic priority under 35 U.S.C. §119(e) to U.S. Provisional Patent Application No. 60/460,077 filed Apr. 3, 2003.

### FIELD OF THE INVENTION

The claimed invention relates generally to the field of fluidic containment devices and more particularly, but not by way of limitation, to an apparatus and method for measuring a leak rate for a device under test.

### BACKGROUND

It is often desirable to perform leak testing of fluidic containment devices, such as pressurized and nonpressurized vessels, conduits, housings, etc. Such testing is carried out to determine the extent to which a selected fluid (e.g., air) escapes from the device. This is particularly useful in manufacturing certification testing, in that a determined leak rate can be compared to a standard to determine compliance prior to shipment of the device.

Pressure decay detection is one approach in which a leak rate for a particular device under test (DUT) can be determined. Generally, this involves pressurizing the DUT with a fluid from a source, isolating the DUT from the source and then measuring a subsequent drop or decay in the pressure within the DUT.

Flow rate detection is another approach for determining a leak rate for a DUT. This generally involves using a source to pressurize the DUT to a steady state level and then, while maintaining connection with the source, using a flow meter to measure subsequent flow of fluid into the DUT. The rate at which the DUT is “replenis hed” with additional fluid from the source generally indicates the rate at which fluid is leaking from the DUT.

While these methodologies have been found operable, there nevertheless remains a continued need for improvements in the manner in which leak testing is performed so that accurate leak rates can be determined quickly and efficiently. It is to such improvements that the claimed invention is generally directed.

### SUMMARY OF THE INVENTION

In accordance with preferred embodiments, a method and apparatus are provided for performing a leak rate test on a device under test (DUT), such as a data storage device housing.

The apparatus preferably comprises a flow meter which determines a flow rate of a flow of pressurized fluid. A conduit receives the pressurized fluid and conducts a first portion of the pressurized fluid to the DUT, while a bleed orifice removes a second portion of the pressurized fluid from the conduit at a selected removal rate. A controller determines a leak rate for the DUT in relation to the determined flow rate and the selected removal rate.

The method preferably comprises determining a flow rate of a flow of pressurized fluid while providing a first portion of the pressurized fluid to the DUT and diverting a second portion of the pressurized fluid away from the DUT at a selected removal rate. A leak rate for the DUT is then determined in relation to the determined flow rate and the selected removal rate.

Preferably, the pressurized fluid comprises air, although other fluids can be used as desired. A regulator establishes the flow of pressurized fluid, and preferably utilizes a variable orifice size to reduce flow oscillations in the pressurized fluid.

The diversion of the second portion of the pressurized fluid establishes a known “leak” in the system which facilitates the operation of the flow meter at a mid-range value. In this way, even relatively small leak rates (such as 0.5 standard cubic centimeters, sccm at 1.0 inches of water, inH20 or smaller) can be tested using a flow rate approach in a fast and efficient manner.

These and various other features and advantages which characterize the claimed invention will become apparent upon reading the following detailed description and upon reviewing the associated drawings.

### BRIEF DESCRIPTION OF THE DRAWINGS

FIG. 1 is an exploded, perspective view of a data storage device which is subjected to leak rate testing in accordance with preferred embodiments of the present invention.

FIG. 2 is a side elevational, cross-sectional view of a base deck of the device of FIG. 1 to generally illustrate a diffusion path for a housing of the device.

FIG. 3 is a functional block diagram for a flow rate test system constructed and operated in accordance with preferred embodiments of the present invention to perform leak testing of the device of FIG. 1.

FIG. 4 is a flow chart for a LEAK RATE TESTING routine, illustrative of steps preferably carried out by the system of FIG. 3.

### DETAILED DESCRIPTION

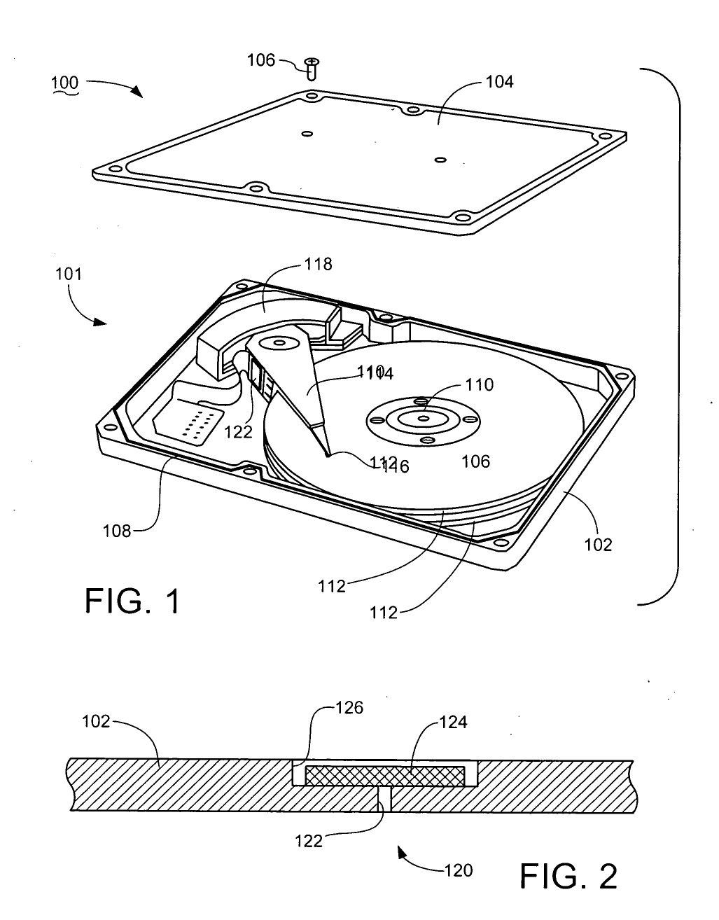

While the claimed invention has utility in any number of different applications, FIG. 1 has been provided to illustrate a particularly suitable environment in which the claimed invention can be advantageously practiced.

FIG. 1 shows an exploded, perspective top plan representation of a data storage device 100 of the type used to magnetically store and retrieve computerized user data. The device 100 includes a housing 101 formed from a base deck 102 and a top cover 104.

The top cover 104 is secured to the base deck 102 using a number of threaded fasteners (one shown at 106). The fasteners 106 apply a compressive force upon an elastomeric gasket 108 extending along the perimeter of the base deck 102 to effect a fluidic seal between the base deck 102 and top cover 104.

The sealed housing 101 protects a number of internal components from the exterior environment. Such components include a spindle motor 110 which rotates a number of data recording discs 112 (in this case, two), and an actuator 114 having a corresponding array of data transducing heads 116. The actuator 114 is pivoted by a voice coil motor (VCM) 118 to position the heads 116 adjacent data tracks (not shown) defined on the disc surfaces.

The heads 116 are configured to be hydrodynamically supported adjacent the various disc surfaces by fluidic currents established by rotation of the discs 112. It is contemplated that the fluid contained within the device housing comprises air, although other fluids can be used as desired (e.g., helium).

When air is used as the ambient fluid, it is often desirable to incorporate a diffusion path provide controlled fluidic communication between the interior of the device 100 and the external environment. In this way, excessive atmospheric pressure differentials can be accommodated and the risk of a rupture of the gasket 108 can be reduced.

FIG. 2 generally illustrates a diffusion path 120 of the device 100 of FIG. 1. The diffusion path 120 includes a conduit 122 that extends through a housing wall (in this case, the base deck 102). While the conduit 122 is shown in FIG. 2 to extend vertically through the thickness of the base deck 102, those skilled in the art will recognize that such conduits are typically elongated and provided with a serpentine or similar configuration to extend the length and surface area of the conduit. Contaminants from the external environment will tend to collect along the walls of the conduit 122 and not reach the interior of the housing.

An internal breather filter 124 is adhered over the conduit 122, and is preferably recessed within a recess 126. The breather filter 124 forms a portion of the diffusion path and operates to adsorb particulates and other fluid-borne contaminants.

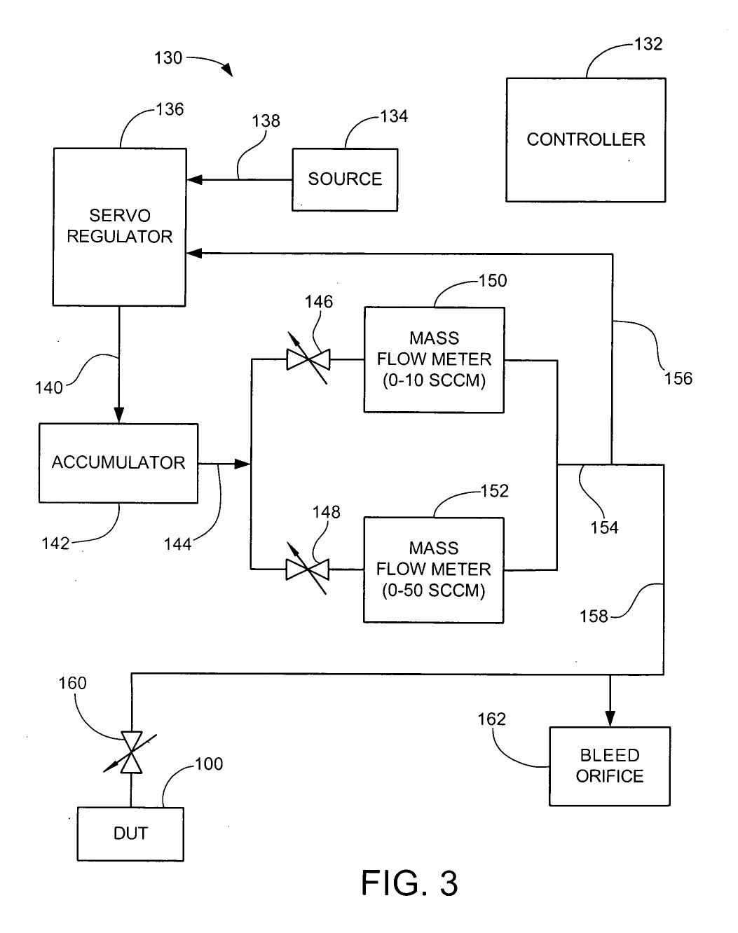

FIG. 3 provides a functional block diagram of a flow rate test system 130 configured to perform a leak rate test of the assembled housing 101 during device manufacturing. It is contemplated that the system 130 is incorporated into an automated manufacturing line used to fabricate a population of devices nominally identical to the device 100 of FIG. 1.

Top level control of the system 130 is provided by a controller 132. The controller 132 is preferably characterized as a programmable processor such as a personal computer (PC) with a graphical user interface (GUI) and a network interface to communicate with a production control network (not shown).

A source 134 supplies filtered, pressurized air at an initial pressure such as 6-8 inches of water, inH20 (1.1-1.5 centimeters of mercury, cmHg) to a servo regulator 136 via conduit 138. The servo regulator 136 outputs a regulated flow of the pressurized air at a reduced, selected level such as 3 inH20 (0.6 cmHg).

While the servo regulator 136 can take any number of constructions, in a preferred embodiment the servo regulator 136 utilizes a proportional (needle) valve that provides a variable orifice size. This generally reduces flow oscillations (signal noise) in the output air, thereby reducing the number of measurement samples and hence, amount of test time required to obtain an accurate flow rate measurement.

Particularly suitable commercial embodiments for the servo regulator 136 are Model PA 317 and Model PA 452 available from Proportion-Air, Inc., McCordsville, Ind., USA.

The output air from the servo regulator 136 is supplied via conduit 140 to an accumulator 142, which generally comprises a chamber into which a volume of the pressurized air accumulates. Such accumulation dampens flow oscillations, enhances thermal equilibrium and facilitates rapid filling of the device under test (DUT) 100.

Outlet flow from the accumulator 142 is provided by a branching conduit 144 to two parallel paths. Each path includes a respective pinch valve 146, 148 and a respective flow meter 150, 152. The pinch valves 146, 148 are preferably solenoid actuated on-off valves operated under control of the controller 132. The flow meters 150, 152 are each respectively configured to determine a flow rate of the pressurized fluid transmitted along each of the respective paths in a known manner.

The flow meters 150, 152 preferably have different measurement ranges; as shown in FIG. 3, the flow meter 150 has a measurement range of from 0 to 10 standard cubic centimeters, sccm, and the flow member 152 has a measurement range of from 0 to 50 sccm. The flow meters 150, 152 are individually selected during testing as explained below.

An exit conduit 154 joins the outputs of the flow meters 150, 152. A feedback conduit 156 provides feedback to the servo regulator 136 for closed loop control. An output conduit 158 extends from the junction of the conduits 154, 156 to a pinch valve 160 proximate the DUT 100. The pinch valve 160 is operated by the controller 132 and serves as the primary on-off valve during testing.

A bleed orifice 162 branches from the conduit 158 and removes air from the conduit 158 at a selected removal rate. The removed air from the bleed orifice 162 can be vented to the atmosphere or recovered for subsequent system use.

For reference, it has been found advantageous to use a bleed orifice with a specified removal rate of 3.5 sccm at 1 inH20 for devices with a leak rate specification of 0.5 sccm at 1 inH20 (such as for the device 100 shown in FIG. 1). For other devices with a lower leak rate specification such as 0.2 sccm at 1 inH20, it has been found advantageous to use a bleed orifice with a specified removal rate of 2.5 sccm at 1 inH20. The particular values selected can be empirically determined based on the requirements of a given application.

It will be noted that the system 130 preferably tests the DUT 100 at a higher pressure range (e.g., 3 inH20) than that specified (e.g., 1 inH20) and then correlates the resulting leak rates back to an equivalent leak rate at the specified pressure range. This further enhances accuracy and reduces test time. Of course, care should be taken to not test at a destructive pressure range if nondestructive testing is the goal.

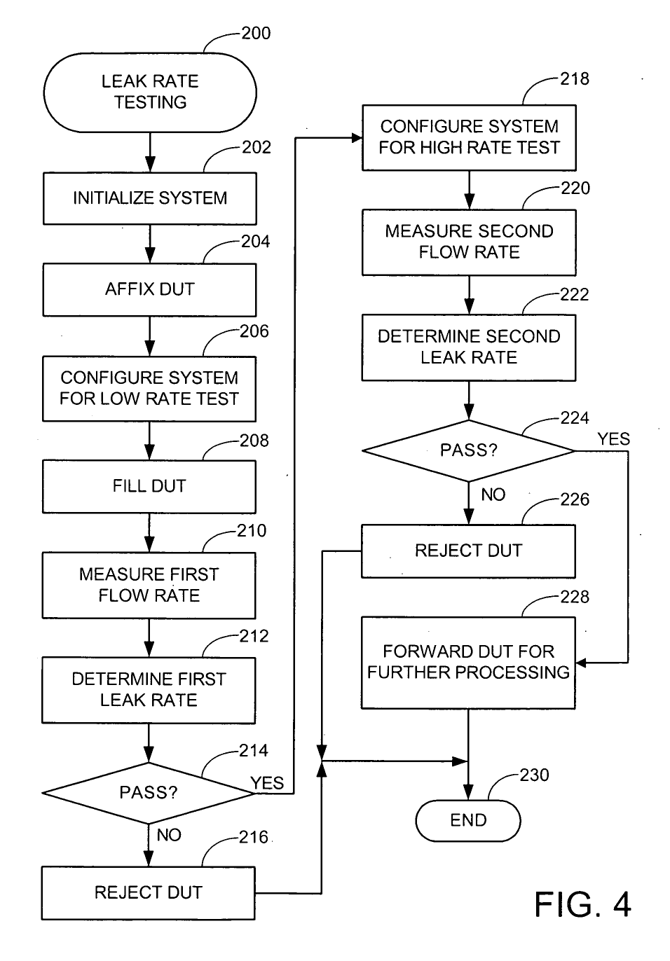

Preferred operation of the system 130 is carried out as generally set forth by a LEAK RATE TESTING routine 200 of FIG. 4. The system 130 is first initialized at step 202. Preferably, the pinch valve 160 is closed, the pinch valve 146 is opened, and the servo regulator 136 operates to fill the accumulator 142 and remaining portions of the system 130 until initial steady state conditions (pressure, temperature, etc.) are achieved. Pinch valve 148 can be opened as well, but preferably remains closed since the system will still fully charge so long valve 146 is opened (air will backfill through flow meter 152).

It will be noted that the bleed orifice 162 preferably operates as a continuous, known “leak” in the system at all times. The volume output of the servo regulator 136 is sized to accommodate this constant removal of air from the pressurized system 130 while still accomplishing this initialization step in a relatively short period of time.

As desired, the initialization step 202 can further include a bleed orifice calibration operation to assess the actual leak rate of the bleed orifice 162. While the bleed rate is determined by the construction of the orifice, it may be desirable to perform this step either periodically or every time through the routine in order to obtain an accurate baseline for the system. By closing valves 148 and 160, opening valve 146 and operating the system in a steady state condition, the flow of pressurized air through the flow meter 150 will generally be due to the removal of air by the bleed orifice 162. Thus, during this calibration operation the flow meter 150 carries out a flow rate measurement while the system 130 is so configured, and this flow rate value is temporarily stored by the controller 132.

At step 204, the DUT 100 is affixed to the system 130. Preferably, the DUT 130 is supplied with an aperture through a wall of the housing 101 over which a suction cup or other fluidic seal mechanism is affixed to provide fluidic engagement between the system 130 and the interior of the housing 101. The aperture is later sealed during subsequent processing of the device 100.

The system 130 is next configured at step 206 to carry out a low rate test. This low rate test measures the leak rate of the housing 101 while the housing is in a fully sealed condition (i.e., without operation of the diffusion path 120 of FIG. 2) in order to test the proper installation and operation of the gasket 108 (FIG. 1). In the present example, it will be contemplated that the specified maximum acceptable leakage of the housing 101 in this condition is 0.2 sccm at 3 inH20, although higher or lower values can be tested as well.

During step 206, an elastomeric stopper or similar mechanism (not shown) is brought into contact with the base deck 102 to close the inlet of the conduit 122 in order to seal off the diffusion path 120 (FIG. 2). The pinch valve 148 is set to a closed position and the pinch valve 146 is set to an open position to bring the first flow meter 150 on-line.

The DUT 100 is next filled at step 208. The pinch valve 160 is opened and air from the precharged conduit 158 flows into the housing. The fill time will be relatively short because the interior of the housing 101 is already filled with air at ambient atmospheric pressure, and the volume of the interior of the housing 101 is relatively small. Locating the pinch valve. 160 as close as practicable to the DUT 100 will also tend to reduce the fill time since this reduces the amount of additional conduit or other volume that needs to be filled once the pinch valve 160 is opened.

The fill step 208 is intended to achieve a desired, steady state pressurized condition for the housing 101. While sensors can be used to monitor and indicate when the desired final condition is reached, a preselected fill time can be empirically determined that is sufficient to ensure the desired steady state condition has been reached. Thus, a timer of the controller 132 is preferably initiated once the pinch valve 160 is opened and the fill step 208 is deemed completed at the conclusion of this preselected fill time.

Once the DUT 100 has been filled, the routine passes to step 210 wherein a flow rate measurement is made by the flow meter 150. From FIG. 3 it can be seen that the flow detected through the flow meter 150 at this point has two components: a first portion which passes along the conduit 158 and into the DUT 100 to replenish air that leaks therefrom, and a second portion which is removed from the conduit 158 by the bleed orifice 162. Unless a failure has occurred within the DUT 100 (e.g., a, blown gasket 108), generally the second portion will be substantially greater than the first portion.

At step 212, the controller 132 determines the leak rate for the housing 101 in relation to the flow rate determined by the flow meter and the removal rate of the bleed orifice 162. Preferably, this is determined in relation to the difference in the flow rate measured during step 210 and the flow rate measured during the calibration operation of step 202 (the balance being the flow caused by leakage through the DUT 100).

It will be noted that although the flow meter 150 has the capability of measuring a relatively low flow rate (i.e., that portion of the flow solely due to housing leakage), using the bleed orifice 162 advantageously brings the overall flow rate measurement into the mid-range of the flow meter 150. This has been found to significantly decrease testing time since fewer samples are required to arrive at an accurate flow measurement. Also, some flow meters such as 150 have been found to be generally more accurate in the mid-range as compared to near the ends of the measurement range.

If the determined leak rate for the DUT 100 exceeds the specified rate, the flow passes from decision step 214 to step 216 where the DUT 100 is rejected and diverted for failure analysis. The failed DUT 100 may be reworked or scrapped and correct actions implemented upstream in the process.

When the determined leak rate is acceptable, the routine passes from decision step 214 to step 218 wherein the system 130 is configured for a high rate test. The high rate test generally verifies whether the breather filter 124 (FIG. 2) is properly installed. It will be noted that if the breather filter 124 is present and properly adhered to the base deck 102, a pressure drop through the diffusion path 120 will fall within a selected range. Contrawise, if the breather filter 124 is “lifted” (that is, not fully adhered within the recess 126), air will be permitted to bypass the filter and flow through the diffusion path 120 at a substantially higher rate.

Accordingly, step 218 includes the closing of valve 146 and the opening of valve 148 to bring the second flow meter 152 on-line. The elastomeric stopper or other mechanism covering the inlet to the conduit 122 is also removed during this step.

At step 220, the flow meter 152 determines a flow rate of the pressurized fluid transmitted by the meter. As will be recognized, this flow rate will comprise the leakage through the bleed orifice 162, the leakage through the diffusion path 120 and the undesired leakage through the gasket 108 or other locations in the DUT 100. Thus, the flow rate obtained during step 220 will tend to be substantially greater than that measured during step 210.

At step 222, the controller 132 uses the flow rate determined during step 220 to obtain an overall leak rate for the DUT 100. As indicated by decision step 224, this second leak rate is compared to a predetermined standard rate and if excessive, the routine passes to step 226 and appropriate failure analysis and corrective actions are taken. If the second leak rate is acceptable, the DUT 100 is accepted and presented for further processing, step 228, and the routine ends at step 230.

The foregoing methodology advantageously allows flow rate testing to be performed in a fast and efficient manner. The methodology can accommodate a wide range of specified leak rates, including very low specified leak rates that heretofore have not generally been deemed suitable for testing using a flow rate approach due to the time required to collect sufficient samples, etc.

By contrast, it has been found that the flow rate testing of the routine of FIG. 4 can be carried out in around six seconds, and the entire test (including all requisite manipulations of the DUT 100) can be carried out in around 10 seconds. The routine has been found to be highly accurate and repeatable, including for device housings with even lower specified leak rates such as 0.1 sccm at 1 inH20.

While air has been utilized in the foregoing embodiments, it will be recognized that any number of different fluids can be used as desired, depending upon the requirements of a given application.

It will now be understood that the present invention, as embodied herein and as claimed below, is generally directed to an apparatus and method for performing leak rate testing for a device under test (such as 100).

The apparatus preferably comprises a flow meter (such as 150, 152) which determines a flow rate of a flow of pressurized fluid; a conduit (such as 158) which receives the pressurized fluid and conducts a first portion thereof to the DUT; a bleed orifice (such as 162) which removes a second portion of the pressurized fluid from the conduit at a selected removal rate; and a controller (such as 132) which determines a leak rate for the DUT in relation to the determined flow rate and the selected removal rate.

Preferably, the flow of pressurized fluid is regulated by a regulator (such as 136) upstream of the flow meter, and the regulator preferably utilizes a variable orifice size to reduce flow oscillations.

The method preferably comprises steps of determining a flow rate of a flow of pressurized fluid while providing a first portion of the pressurized fluid to a device under test (DUT) and diverting a second portion of the pressurized fluid away from the DUT at a selected removal rate (such as by steps 210, 220); and determining a leak rate for the DUT in relation to the determined flow rate and the selected removal rate (such as by steps 212, 222).

For purposes of the appended claims, the term “flow meter” will be construed broadly to cover any type of device or system that determines a flow rate for a flow of pressurized fluid. The recited “steps for determining the leak rate” will be understood to correspond to at least steps 212 or 222 of FIG. 4.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application without departing from the spirit and scope of the present invention.

In addition, although the embodiments described herein are directed to leak rate testing of a data storage device housing, it will be appreciated by those skilled in the art that the claimed subject matter is not so limited, but rather extends to any number of different types of devices under test (DUT).

What is claimed is:

1. An apparatus, comprising:
a flow meter which determines a flow rate of a flow of pressurized fluid;
a conduit which receives the pressurized fluid and conducts a first portion thereof to a device under test (DUT);
a bleed orifice which removes a second portion of the pressurized fluid from the conduit at a selected removal rate, wherein the apparatus determines a leak rate for the DUT in relation to the determined flow rate and the selected removal rate.

2. The apparatus of claim 1, further comprising a regulator upstream of the flow meter which regulates the pressure of the pressurized fluid.

3. The apparatus of claim 2, wherein the regulator utilizes a variable orifice size to reduce flow oscillations in the pressurized fluid.

4. The apparatus of claim 1, further comprising an accumulator upstream of the flow meter, the accumulator comprising a chamber which accumulates a volume of the pressurized fluid.

5. The apparatus of claim 1, further comprising a valve coupled to the conduit and configured to respectively prevent and permit flow of the pressurized fluid to the DUT.

6. The apparatus of claim 5, wherein the valve is placed at a distal end of the conduit proximate the DUT.

7. The apparatus of claim 5, wherein the selected removal rate for the bleed orifice is determined in relation to a flow rate measured by the flow meter while the valve is configured to prevent flow of the pressurized fluid to the DUT.

8. The apparatus of claim 1, wherein the flow meter is configured to determine flow rates over a selected range from a first lower value to a second higher value, wherein a specified leak rate of the DUT is at a level proximate the first lower value, and wherein the selected removal rate of the bleed orifice causes the determined flow rate of the flow meter to be a mid-range value between the first lower value and the second higher value.

9. The apparatus of claim 1, wherein the flow meter is characterized as a first flow meter, wherein the apparatus further comprises a second flow meter coupled to the conduit in parallel to the first flow meter, and wherein the apparatus further determines a leak rate for the DUT in relation to a determined flow rate from the second flow meter and the selected removal rate.

10. The apparatus of claim 1, wherein the controller further compares the determined leak rate for the DUT to a specified acceptable leak rate.

11. The apparatus of claim 10, wherein the specified acceptable leak rate corresponds to a value equal to or less than 0.5 standard cubic centimeters (sccm) at 1.0 inches of water (inH20).

12. The apparatus of claim 1, wherein the pressurized fluid comprises air.

13. The apparatus of claim 1, wherein the DUT comprises a housing of a data storage device.

14. A method, comprising:
determining a flow rate of a flow of pressurized fluid while providing a first portion of the pressurized fluid to a device under test (DUT) and diverting a second portion of the pressurized fluid away from the DUT at a selected removal rate; and
determining a leak rate for the DUT in relation to the determined flow rate and the selected removal rate.

15. The method of claim 14, comprising a prior step of measuring the selected removal rate by determining the flow rate of the pressurized fluid while preventing said first portion from reaching the DUT.

16. The method of claim 14, further comprising using a flow meter to obtain the determined flow rate and a bleed orifice to divert the second portion of the pressurized fluid away from the DUT at the selected removal rate.

17. The method of claim 16, wherein the flow meter is configured to determine flow rates over a selected range from a first lower value to a second higher value, wherein a specified leak rate of the DUT is at a level proximate the first lower value, and wherein the selected removal rate of the bleed orifice causes the determined flow rate of the flow meter to be a mid-range value between the first lower value and the second higher value.

18. The method of claim 14, further comprising comparing the determined leak rate for the DUT to a specified acceptable leak rate.

19. The method of claim 18, wherein the specified acceptable leak rate of the comparing step corresponds to a value equal to or less than 0.5 standard cubic centimeters (sccm) at 1.0 inches of water (inH20).

20. The method of claim 14, further comprising establishing the flow of pressurized fluid using a regulator.

21. The method of claim 14, wherein the regulator of the establishing step utilizes a variable orifice size to reduce flow oscillations in the pressurized fluid.

22. The method of claim 14, wherein the pressurized fluid comprises air.

23. The method of claim 14, wherein the DUT comprises a data storage device housing.

24. An apparatus, comprising:
a flow meter which determines a flow rate of a flow of pressurized fluid;
a conduit which receives the pressurized fluid and conducts a first portion thereof to a device under test (DUT);
a bleed orifice which removes a second portion of the pressurized fluid from the conduit at a selected removal rate, wherein the apparatus determines a leak rate for the DUT by steps for determining the leak rate.
